(19) United States
(12) Patent Application Publication
(10) Pub. No.: US 2023/0177522 A1
(43) Pub. Date: Jun. 8, 2023

(54) METHOD FOR OPERATING AN EMISSION CERTIFICATE EXCHANGE PLATFORM, AND EMISSION CERTIFICATE EXCHANGE PLATFORM

(71) Applicant: MERCEDES-BENZ GROUP AG, Stuttgart (DE)

(72) Inventors: Alexander SCHÖNHALS, Pforzheim (DE); Rebecca FRENZ, Stuttgart (DE); Peter GOEDECKE, Obersulm (DE)

(21) Appl. No.: 17/924,408

(22) PCT Filed: May 3, 2021
(86) PCT No.: PCT/EP2021/061569

§ 371 Date: Nov. 10, 2022

(30) Foreign Application Priority Data
May 11, 2020 (DE) 10 2020 002 846.2

(51) Int. Cl. G06Q 30/018

(52) U.S. Cl. CPC G06Q 30/018

(57) ABSTRACT

A method for operating an emission certificate exchange platform involves balancing a positive pollutant balance of a motor vehicle using emission certificates. At least one operating parameter of the motor vehicle is transferred to an electronic computer unit of the emission certificate exchange platform outside of the motor vehicle. The positive pollutant balance of the motor vehicle is determined by the electronic computer unit depending on the operating parameter. At least one third party having a negative pollutant balance is identified by the electronic computer unit, and an emission certificate exchange is carried out between the motor vehicle and the third party by means of the emission certificate exchange platform.

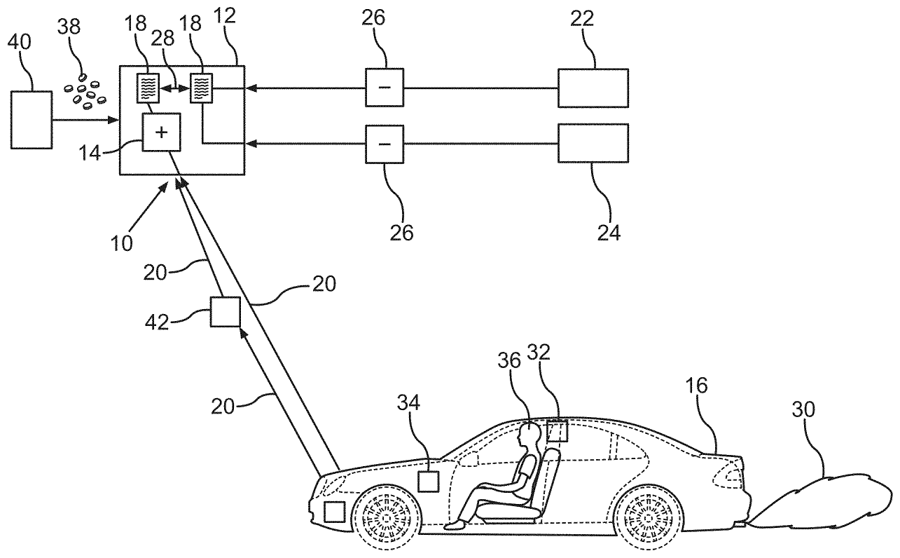

### BACKGROUND AND SUMMARY OF THE INVENTION

Exemplary embodiments of the invention relate to a method for operating an emission certificate exchange platform for balancing a positive pollutant balance of a motor vehicle by means of emission certificates, as well as to an emission certificate exchange platform.

It is already known that climate change and its consequences alter the thinking of users of motor vehicles, and their relationship to motor vehicles is changing. According to current studies, a significant part of the emitted pollutant, in particular CO₂, can be compensated by planting trees, for example. The exchange of emission certificates is further already known. A coal power station has a positive pollutant balance, for example, which means that more pollutant is generated by this coal power station than this power station is allowed to generate in relation to a limit value. Other businesses, however, have a negative pollutant balance, which means that the pollutant emission of this business lies below a particular threshold value. These emission certificates can then be exchanged on an emission certificate exchange for a fee. The coal power station then buys emission certificates, for example, in order not to receive a punishment from the further business having the negative pollutant balance, for example, such that a balancing of the pollutant balances then occurs in turn.

U.S. Pat. No. 8,280,646 B2 discloses a method for compensating for carbon dioxide (CO₂) emissions, comprising the steps of capturing CO₂ emissions data of a vehicle, transferring the CO₂ emissions data to a data capture unit, which then saves the captured CO₂ emissions data and creates a CO₂ emissions report. The CO₂ emissions report is used for the dissemination of a tailored CO₂ balance package, which is selected by a vehicle owner. The selected CO₂ compensation package balances out the CO₂ emissions with bought credits to neutralize the CO₂ released by the vehicle. The owner of the package receives a visual indicator that shows that the vehicle is currently carbon neutral.

Exemplary embodiments of the present invention are directed to a method and an emission certificate exchange platform, by means of which an improved balancing of pollutant balances can be carried out.

An aspect of the invention relates to a method for operating an emission certificate exchange platform for balancing a positive pollutant balance of a motor vehicle by means of emission certificates, in which at least one operating parameter of the motor vehicle is transferred to an electronic computer unit of the emission certificate exchange platform outside of the motor vehicle.

It is provided that a positive pollutant balance of the motor vehicle is determined by means of the electronic computer unit depending on the operating parameter, wherein at least one third party having a negative pollutant balance is identified by means of the electronic computer unit, and an emission certificate exchange is carried out between the motor vehicle and the third party by means of the emission certificate exchange platform.

The carrying out of an improved balancing of pollutant balances is thus enabled. In particular, for example, a positive pollutant balance of the motor vehicle, which means that the motor vehicle generates more pollutant than a given threshold value, can be balanced with the third party having the negative pollutant balance, which means that the third party generates less pollutant than the given threshold value.

It is in particular quasi provided that the at least one operating parameter is read out via a CAN interface of the motor vehicle, for example, and is transferred to the electronic computer unit outside of the motor vehicle via a mobile network, for example the internet. The electronic computer unit outside of the motor vehicle can also be described as a so-called backend. The electronic computer unit outside of the motor vehicle then determines the positive pollutant balance of the motor vehicle based on the at least one transferred operating parameter. The electronic computer unit outside of the motor vehicle identifies suitable climate protection organizations, for example, based on the underlying information from a portfolio for a user of the motor vehicle. The third party or the climate protection organizations that have a negative pollutant balance, and are ready to neutralize the CO2 emissions, for example, are likewise saved and identified on the emission certificate exchange platform.

These third parties then have an interest in compensating for the pollutants in turn in a manner suitable for their cause. There are potential parties in the emissions trade, for example, who could neutralize emissions via their certified negative pollutant balance, but who consciously hold back because coal power stations should not be supported by the third parties, for example. A current price of the emission certificates is called up from the emission certificate exchange over a corresponding interface immediately after the best-suited match is identified. Exactly the quantity is calculated for the causer, in other words for the user of the motor vehicle, which has been calculated for their emissions at exactly this point in time. This amount is made available to the balancing party, in other words to the third party, in order to reach a certified compensation for pollutants.

It is thus in particular enabled that users can directly compensate for the emission or the pollutant emission of the motor vehicle. The indirect usage of the CO₂ certificates, in particular the trading of the CO₂ certificates, raises the price of the certificates as a side-effect, which means in turn that environmental polluters, e.g., coal power stations, can no longer afford the emission certificates, whereby the focus on sustainability for products increases. Overall, a transparency can be realized on the emission certificate market. Environmental pollution can be balanced directly at the source of the environmental pollution by means of the emission certificate exchange platform.

It can be provided that the operating parameter is directly or indirectly transferred to the emission certificate exchange platform. A further electronic computer unit outside of the motor vehicle can be shifted between the motor vehicle and the emission certificate exchange platform in the indirect manner, for example. The operating parameter is thus not directly transferred to the emission certificate exchange platform, but can be anonymized by the further electronic computer unit, for example.

According to an advantageous embodiment, the positive pollutant balance of the motor vehicle is determined by means of the electronic computer unit outside of the motor vehicle based on general information of the motor vehicle. The size of the motor vehicle and the weight of the motor vehicle can be seen as general information of the motor vehicle, for example. Aerodynamic key figures of the motor vehicle can further be seen as general information, for example. A motorization of the motor vehicle can further also be determined as general information. The positive pollutant balance can then in turn be determined as cumulated positive pollutant balance based on this information by means of the electronic computer unit. It is thus enabled that the positive pollutant balance of the motor vehicle can be reliably determined.

It is further advantageous if a current position of the motor vehicle and/or a current speed of the motor vehicle and/or a current acceleration of the motor vehicle and/or a current fuel usage of the motor vehicle and/or a current charge state of the motor vehicle are transferred to the electronic computer unit as operating parameters. It is thus, in particular, enabled that a detailed determining of the positive pollutant balance of the motor vehicle can be carried out based on these operating parameters. The positive pollutant balance of the motor vehicle can thus, in particular, be determined based on usage data depending on the vehicle, such as the acceleration or the fuel usage, for example. It is thus enabled that the emission certificate exchange can reliably be carried out.

The third party is identified based on a user profile of a user of the motor vehicle in a further advantageous embodiment. The user of the motor vehicle can specify with which third party they would like to carry out the emission certificate exchange, for example. The emission certificate exchange can thus be carried out specifically to the customer.

It has further proved advantageous if the third party is rewarded for the emission certificate exchange by means of a fee, and the rewarding of the third party for the emission certificate exchange is performed by a user of the motor vehicle. In other words, the user pays a fee to the third party that has the negative pollutant balance for the positive pollutant balance and the balancing with emission certificates. An exchange of the emission certificates and a simultaneous reward thus takes place. This has the advantage that the user is encouraged to generate as little pollutant as possible, whereby an environmental protection can be realized.

It has further proved advantageous if the size of the reward is determined by means of the electronic computer unit based on a price on an emission certificate exchange. The electronic computer unit outside of the motor vehicle is thus, in particular, also coupled with the emission certificate exchange. Current prices are traded for corresponding emission certificates on the emission certificate exchange. The size of the reward for the third party can be determined in turn on the basis of this current price.

It is further advantageous if the third party is identified depending on a current position of the motor vehicle. It is thus enabled that the motor vehicle that emits the pollutant in a given place, for example, searches for a third party in this place, or at least near this place, which balances the negative pollutant balance. The local pollutant balance can thus be balanced such that a local exchange of the emission certificates can be carried out.

According to a further advantageous embodiment, the third party is identified depending on a potential reward budget of a user of the motor vehicle. The budget of the user can thus, in particular, also be taken into account in the emission certificate trade or when the third party is determined. An improved emission certificate exchange is thus enabled.

It has further proved advantageous if the third party is identified depending on a kind of pollutant emission of the motor vehicle. A CO₂ emission or a carbon monoxide emission can be seen as a pollutant emission, for example. The third party can then specify, for example, that they only want to balance CO₂ emissions. It is thus enabled that the emission certificate exchange can be carried out in turn depending on the pollutant emission.

A further aspect of the invention relates to an emission certificate exchange platform for balancing a positive pollutant balance of a motor vehicle by means of emission certificates, having at least one electronic computer unit outside of the motor vehicle, wherein the emission certificate exchange platform is designed to carry out a method according to the previously named aspect. The method is in particular carried out by means of the emission certificate exchange platform.

Advantageous embodiments of the method should be viewed as advantageous embodiments of the emission certificate exchange platform. The emission certificate exchange platform also has representational features that enable the method or an advantageous embodiment of the latter to be carried out.

Further advantages, features and details of the invention result from the following description of a preferred exemplary embodiment and with reference to the drawing. The features and combinations of features previously given in the description and the features and combinations of features given in the description of figures below and/or shown alone in the single FIGURE can be used not only in the particular combination given, but also in other combinations or in isolation without moving beyond the scope of the invention.

### BRIEF DESCRIPTION OF THE SOLE FIGURE

Here the sole FIGURE shows a schematic side view of an embodiment of an emission certificate exchange platform.

The same elements, or elements with the same function, are provided with the same reference numerals in the FIGURE.

### DETAILED DESCRIPTION

The sole FIGURE shows an embodiment of an emission certificate exchange platform 10 in a schematic side view. The emission certificate exchange platform 10 has an electronic computer unit 12 outside of the motor vehicle. The emission certificate exchange platform 10 is designed to balance a positive pollutant balance 14 of a motor vehicle 16 by means of emission certificates 18.

In the method for operating the emission certificate exchange platform 10, at least one operating parameter 20 of the motor vehicle 16 is transferred to the electronic computer unit 12, outside of the vehicle, of the emission certificate exchange platform 10 to balance the positive pollutant balance 14 of the motor vehicle 16 by means of the emissions certificates 18. This can, for example, be carried out by means of a mobile network, for example the internet. The emission certificate exchange platform 10 can also be described as a backend.

It is provided that the positive pollutant balance 14 of the motor vehicle 16 is determined by means of the electronic computer unit 12 depending on the operating parameter 20, wherein at least one third party 22, 24 is identified by means of the electronic computer unit 12, the third party having a negative pollutant balance 26, and an emission certificate exchange 28 between the motor vehicle 16 and the third party 22, 24 is carried out by means of the emission certificate exchange platform 10.

A first third party 22 and a second third party 24 are presently shown, in particular. The third parties 22, 24 can be climate protection organizations or businesses having a negative pollutant balance 26, for example.

A positive pollutant balance should presently be seen, in particular, as an emission of a pollutant 30 above a given threshold limit for the motor vehicle 16, for example. A negative pollutant balance 26 should presently be understood to mean that less pollutant 30 is emitted than is provided for the business or the third party 22, 24. The two pollutant balances 14, 26 can then be balanced in turn such that a neutral pollutant balance can be realized.

It can, in particular, be provided that the positive pollutant balance 14 of the motor vehicle 16 is determined by means of the electronic computer unit 12 outside of the motor vehicle based on general information of the motor vehicle 16, such as a size of the motor vehicle 16 or a weight of the motor vehicle 16, for example. A current position of the motor vehicle 16 can, for example, be determined as an operating parameter 20 in turn, for example via a navigation unit 32 of the motor vehicle 16, and/or a current speed of the motor vehicle 16 and/or a current acceleration of the motor vehicle 16 and/or a current fuel usage of the motor vehicle 16 and/or a current charge state of the motor vehicle 16 are transferred to the electronic computer unit 12, wherein the positive pollutant balance 14 can then be determined in turn depending on this operating parameter 20.

It can be provided that the operating parameter 20 is directly or indirectly transferred to the emission certificate exchange platform 10. A further electronic computer unit 42 outside of the vehicle between the motor vehicle 16 and the emission certificate exchange platform 10 can be shifted in the indirect manner, for example. The operating parameter 20 is thus not directly transferred to the emission certificate exchange platform 10, but can instead be anonymized by the further electronic computer unit 42, for example. The further electronic computer unit 42 can be provided by a motor vehicle producer, for example.

It can further be provided that the third party 22, 24 is identified based on a user profile 34 of a user 36 of the motor vehicle 16. The third party 22, 24 can further be identified depending on the current position of the motor vehicle 16. The third party 22, 24 can further be identified depending on a potential reward budget of the user 36 of the motor vehicle 16. It can further be provided that the third party 22, 24 can be identified depending on a kind of pollutant emission of the motor vehicle 16.

The FIGURE further shows, in particular, that the third party 22, 24 is rewarded for the emission certificate exchange 28 by means of a fee, and the rewarding of the third party 22, 24 for the emission certificate exchange 28 is carried out by the user 36 of the motor vehicle 16. The size of the reward can here be determined based on a price 38 in an emission certificate exchange 40 by means of the electronic computer unit 12.

In other words, it can be provided that the operating parameter 20 of a CAN interface of the motor vehicle 16, for example, can be read and sent to the electronic computer unit 12 outside of the vehicle over the internet. The electronic computer unit 12 outside of the motor vehicle calculates a cumulated pollutant usage based on the available information on the motor vehicle 16, but also on usage data related to the vehicle, such as the acceleration or the fuel usage of the motor vehicle 16, for example.

The emission certificate exchange platform 10 then identifies suitable climate protection organizations, in particular the third parties 22, 24, based on the underlying information from the customer portfolio, but also of the specified criteria, such as, for example, the location of the motor vehicle 16, the specified financing budget of the user 36 and the intention, for example to protect the climate.

On the other side there are climate protection organizations, in particular third parties 22, 24, having a negative pollutant balance 26, and that are prepared to neutralize CO₂ emissions as a pollutant 30, for example. These organizations also have an interest in compensating for the pollutants 30 in a manner suitable for their cause. There are potential parties in the emissions trade, for example, that could neutralize the emissions via their certified negative pollutant balance 26, but who consciously hold back because they would thus legitimize coal power stations as pollutant generators having a positive pollutant balance 14, for example. A current price 38 of the emission certificates 18 is called up from the emission certificate exchange 40 over a corresponding interface immediately after the best-suited match is identified. Exactly the quantity is calculated for the causer which has been calculated for their emissions at this point in time. This amount is made available to the balancing party in order to reach a certified compensation for pollutants 30.

Overall, the invention shows a platform for the automatic exchange of participants of the emission certificate trade.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-10. (canceled)

11. A method for operating an emission certificate exchange platform to balance a positive pollutant balance of a motor vehicle using emission certificates, the method comprising:
receiving, by a computer of the emission certificate exchange platform and which is outside of the vehicle, at least one operating parameter of the motor vehicle;
determining, by the computer, the positive pollutant balance of the motor vehicle depending on the received operating parameter;
identifying, by the computer, at least one third party having a negative pollutant balance; and
performing, by the emission certificate exchange platform, an emission certificate exchange between the motor vehicle and the at least one third party.

12. The method of claim 11, further comprising:
determining, by the computer, the positive pollutant balance of the motor vehicle on general information of the motor vehicle.

13. The method of claim 11, wherein the computer receives, as operating parameters of the motor vehicle, from the motor vehicle a current position of the motor vehicle, a current speed of the motor vehicle, a current acceleration of the motor vehicle, a current fuel usage of the motor vehicle, or a current charge state of the motor vehicle.

14. The method of claim 11, wherein the computer identifies the at least one third party based on a user profile of a user of the motor vehicle.

15. The method of claim 11, wherein the at least one third party is rewarded for the emission certificate exchange by a fee, and the rewarding of the at least one third party for the emission certificate exchange is performed by a user of the motor vehicle.

16. The method of claim 15, wherein a size of the reward is determined by the computer based on a price on an emission certificate exchange.

17. The method of claim 11, wherein the at least one third party is identified depending on a current position of the motor vehicle.

18. The method of claim 11, wherein the at least one third party is identified depending on a potential reward budget of a user of the motor vehicle.

19. The method of claim 11, wherein the at least one third party is identified depending on a kind of pollutant emission of the motor vehicle.

20. An emission certificate exchange platform for balancing a positive pollutant balance of a motor vehicle using emission certificates, the emission certificate exchange platform comprising:
a computer located outside of the motor vehicle, wherein the computer is configured to
receive at least one operating parameter of the motor vehicle;
determine the positive pollutant balance of the motor vehicle depending on the received operating parameter; and
identify at least one third party having a negative pollutant balance; and
wherein the emission certificate exchange platform is configured to perform an emission certificate exchange between the motor vehicle and the at least one third party.
